(19) United States
(12) Patent Application Publication
(10) Pub. No.: US 2013/0346164 A1
(43) Pub. Date: Dec. 26, 2013

(54) PEER-TO-PEER (P2P) CURRENCY PLATFORM INCORPORATING DEMURRAGE

(71) Applicant: RAJKUMAR RAMAMURTI, San Francisco, CA (US)

(72) Inventor: RAJKUMAR RAMAMURTI, San Francisco, CA (US)

(21) Appl. No.: 13/527,654

(22) Filed: Jun. 20, 2012

(51) Int. Cl. G06Q 30/02; G07C 13/00

(52) U.S. Cl. 705/12; 705/14.39

(57) ABSTRACT

A method includes providing, through an agent executing on a computing platform at a data processing device, a capability to a user of the data processing device to form a group of members. Each of the members is associated with a data processing device coupled to the data processing device forming the group through Internet. The method also includes generating, through the data processing device forming the group, a currency to be distributed across the members as a value exchange token for goods and/or services within the group, and providing a capability to each member to participate in management of the currency within the group. Further, the method includes recording currency transactions within the group through a currency server, and implementing demurrage on the currency to incentivize quick spending on part of the members. The demurrage is associated with a decrease in value of the currency over time.

### FIELD OF TECHNOLOGY

This disclosure relates generally to currency generation and, more particularly, to a method, an apparatus and/or a system of a peer-to-peer (P2P) currency platform incorporating demurrage.

### BACKGROUND

Currency, in general, may be created, defined, authorized, printed, minted and/or wholly facilitated by a government of a country. The value of the currency may commonly be declared by fiat and backed by faith in the commitment of the government and the willingness of the government to uphold value thereof. A central bank or a Ministry of Finance may be authorized by the government to solely determine the monetary policy thereof, with varying degrees of independence from outside political influence and oversight.

Alternate modes of transactions such as reciprocity-based barter systems have existed in various forms throughout history. Despite the aforementioned alternate modes, transactions based on government currency dominate commerce. Through factors including but not limited to monetary czars having the capability to literally change the supply of money to impact consumer behavior, supply of government currency may be limited at any point in time. The aforementioned limitation may be experienced differently by different communities based on relative access to capital. Abundance in capital may make it easier for entities such as individuals to obtain loans to start businesses, thereby kick-starting labor markets in communities associated therewith.

However, in communities where capital is scarce, individuals may find it difficult to progress and/or prosper.

### SUMMARY

Disclosed are methods, an apparatus and/or a system of a peer-to-peer (P2P) currency platform incorporating demurrage.

In one aspect, a method includes providing, through an agent executing on a computing platform at a data processing device, a capability to a user of the data processing device to form a group of members. Each of the members is associated with a data processing device coupled to the data processing device forming the group through Internet. The method also includes generating, through the data processing device forming the group, a currency to be distributed across the members as a value exchange token for goods and/or services within the group, and providing a capability to each member associated with a data processing device to participate in management of the currency within the group.

Further, the method includes recording currency transactions within the group through a currency server coupled to each of the data processing devices through the Internet, and implementing, through the currency server, demurrage on the currency to incentivize quick spending on part of the members of the group. The demurrage is associated with a decrease in value of the currency over time. The currency server is a server or a network of servers.

In another aspect, a peer-to-peer (P2P) currency network includes a number of data processing devices, with each data processing device being configured to execute an agent on a computing platform thereat, a network, and a currency server coupled to the number of data processing devices through the network. The currency server is a server or a network of servers. The agent on a data processing device is configured to enable a user thereof to form a group of members, with each of the members being associated with a data processing device of the number of data processing devices.

The agent is further configured to provide the user of the data processing device forming the group a capability to generate a currency to be distributed across the members as a value exchange token for goods and/or services within the group. The agent at each data processing device is configured to provide a corresponding member with a capability to participate in management of the currency within the group. The currency server is configured to record currency transactions within the group, and to implement demurrage on the currency to incentivize quick spending on part of the members of the group. The demurrage is associated with a decrease in value of the currency over time.

In yet another aspect, a storage medium, readable through a data processing device and including instructions embodied therein configured to executable through the data processing device, is disclosed. The storage medium includes instructions associated with providing a capability to a user of the data processing device to form a group of members, with each of the members being associated with a data processing device coupled to the data processing device forming the group through Internet. The storage medium also includes instructions associated with generating a currency to be distributed across the members as a value exchange token for goods and/or services within the group, and instructions associated with providing a capability to each member associated with a data processing device to participate in management of the currency within the group.

The storage medium also includes instructions associated with accessing, from a currency server configured to record currency transactions within the group coupled to each of the data processing devices through the Internet and implement demurrage on the currency, a value of the currency in accordance with the demurrage implemented to enable incentivizing a member to quickly spend currency associated therewith. The demurrage is associated with a decrease in value of the currency over time.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a peer-to-peer (P2P) currency network set up over the Internet, according to one or more embodiments.

FIG. 2 is a schematic view of interaction of a group of data processing devices with a currency server of the P2P currency network of FIG. 1, according to one or more embodiments.

FIG. 3 is an illustrative view of an example user interface at a data processing device of a user member of the group of FIG. 2 after a custodian initiates a voting process.

FIG. 4 is a schematic view of example modules stored in a memory of the currency server of the P2P currency network of FIG. 1, according to one or more embodiments.

FIG. 5 is an illustrative view of an example currency generated through the P2P currency network of FIG. 1.

FIG. 6 is a schematic view of a user case scenario of the P2P currency network of FIG. 1 with geospatial constraints.

FIG. 7 is a schematic view of another use case scenario of the P2P currency network of FIG. 1, where the P2P currency network is utilized as a gaming system.

FIG. 8 is a process flow diagram detailing the operations involved in a method of realizing a P2P currency platform incorporating demurrage, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of a peer-to-peer (P2P) currency platform incorporating demurrage. Although the present embodiments have been described with reference to specific example embodiments, it will be evident that various modifications and changes may be made to these embodiments without departing from the broader spirit and scope of the various embodiments.

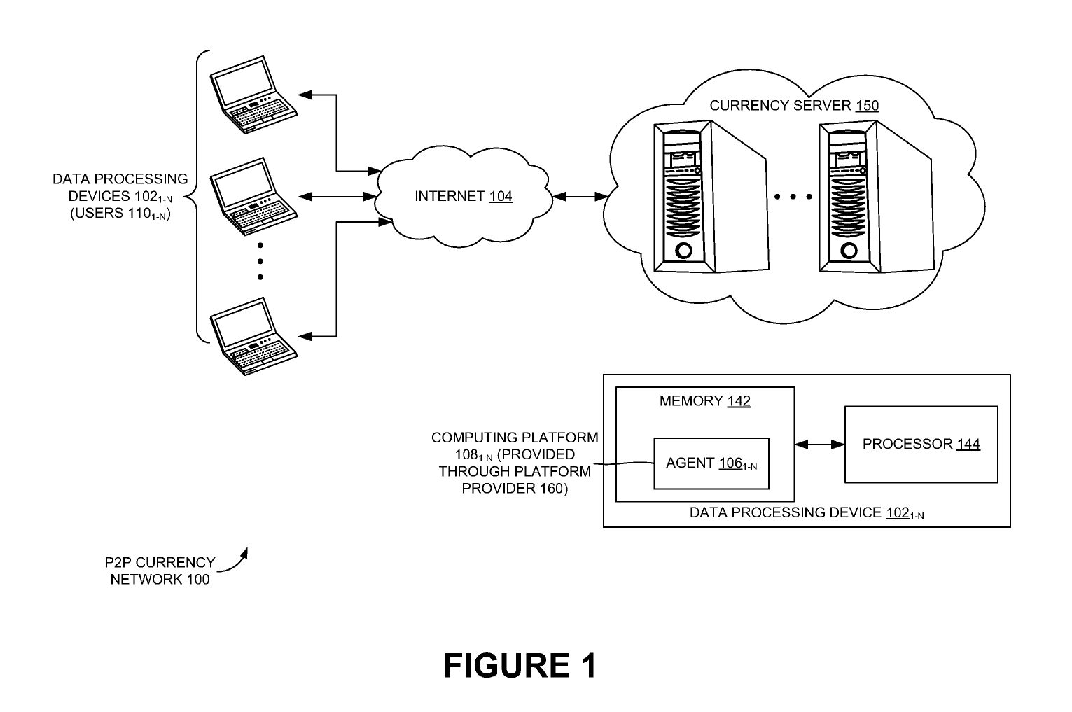

FIG. 1 shows a peer-to-peer (P2P) currency network 100 set up over Internet 104, according to one or more embodiments. In one or more embodiments, P2P currency network 100 may include a number of data processing devices 102_{1-N} coupled to one another through Internet 104. In one or more embodiments, each data processing device 102_{1-N} of the number of data processing devices 102_{1-N} may execute an agent 106_{1-N} (e.g., shown as being stored in a memory 142 and being executable on processor 144 communicatively coupled to memory 142) thereon to enable communication between the number of data processing devices 102_{1-N}. In one or more embodiments, agent 106_{1-N} may execute on a computing platform 108_{1-N} provided through a platform provider 160. In one or more embodiments, agent 106_{1-N} may also be provided through platform provider 160.

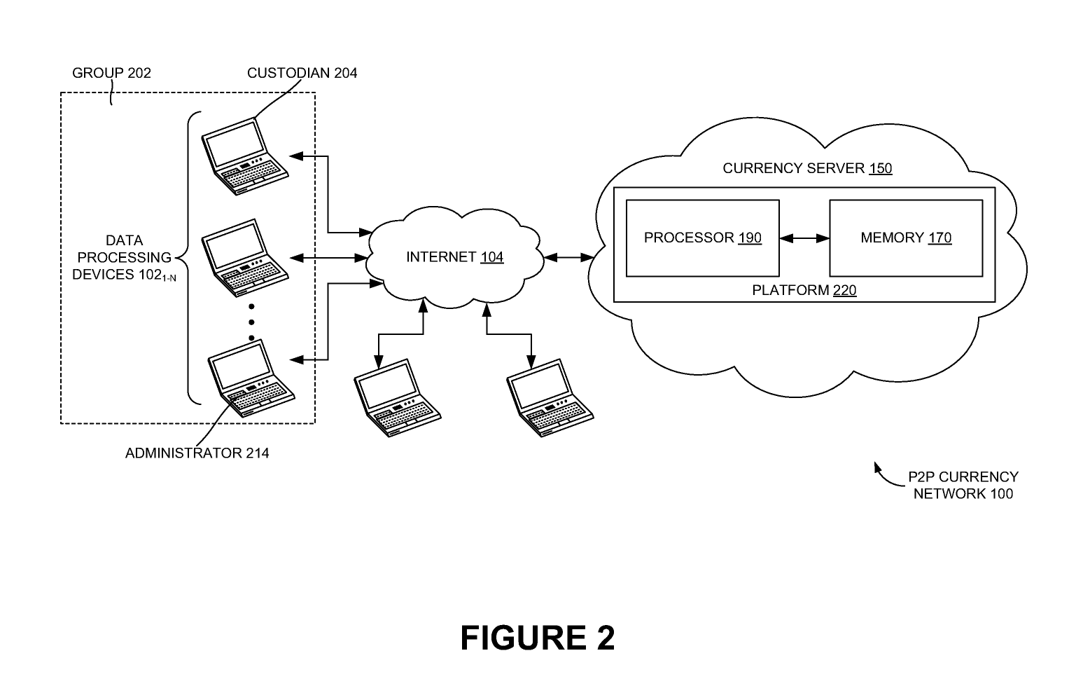

In one or more embodiments, agent 106_{1-N} may be configured to enable creation, distribution, administration and exchange of currencies amongst entities for the purpose of trading value in the form of good(s) and/or service(s) through the execution thereof on computing platform 108_{1-N}. In one or more embodiments, the entities may be individuals, communities, organizations, cities, states and/or even countries. In one or more embodiments, P2P currency network 100 may include a currency server 150 configured to possess one or more critical functionalities associated with P2P currency network 100. In one or more embodiments, currency server 150 may be a network of a number of servers, each having one or more functionalities associated therewith, integrated to have the capability to execute processes as a collective. For example, currency server 150 (to be discussed in detail with reference to FIG. 2) may include storage associated with the transactions through P2P currency network 100. In one or more embodiments, each of data processing devices 102_{1-N} may be coupled to currency server 150 through Internet 104.

In one or more embodiments, each data processing device 102_{1-N} may be associated with a user 110_{1-N} having a capability to initiate a transaction on P2P currency network 100. In one or more embodiments, any of the users 110_{1-N} may create a currency on behalf of a private (or, closed) group and/or a public (or, open group). In one or more embodiments, therefore, each currency may have a user group associated therewith and/or each user group may be associated with different currencies. In an example implementation, a company or an organization may have a number of groups of users including, for example, a Research and Development (R&D) group and a legal services group. Each of the group members may use both currency associated with the R&D group and currency associated with the legal services group.

In one or more embodiments, a user 110_{1-N} creating a currency on behalf of a closed or an open group may do so using specialized tools and/or processes distributed via applications through Internet 104 (and enabled through agent 106_{1-N} executing on computing platform 108_{1-N}). It is obvious that example data processing device(s) 102_{1-N} include but are not limited to a laptop, a personal computer (PC) and a mobile phone. Further, it is obvious that users 110_{1-N} may transact with one another through dissimilar data processing device(s) 102_{1-N} (for example, one user 110_{1-N} having a mobile phone as data processing device 102_{1-N} may interact with another user 110_{1-N} having a laptop as data processing device 102_{1-N}).

A use case of the aforementioned group formation and currency generation therewithin may be in containing value within a group (e.g., a city such as Palo Alto, Calif.). Within organizations/companies, interdepartmental transactions may be conducted based on groups associated therewith. When there is a cash shortage, currency may be created as a value exchange token. If there is not enough cash (or, there is no cash) to buy service(s) within a department/organization, one department may buy service(s) from another using the aforementioned value exchange token.

In one or more embodiments, the abovementioned cash generation and transaction(s) may be backed with government regulated cash. However, in one or more embodiments, the aforementioned may not be required to be used in the routine of transaction(s) using the value exchange tokens (or, currency). Parameters associated with aforementioned backed up cash (e.g., quantity of cash, type of government regulated currency) may be determined through a voting system implemented between group members through data processing devices 102_{1-N} thereof. In one or more embodiments, the process of backing up with cash may be made optional. In example scenarios of transactions and groups involving departments of a company or an organization, the currency may be backed merely by faith.

Consider an example company titled ABCD informational technology (IT) services. Within the aforementioned company, the accounting department may require borrowing services from the cafeteria. In order to borrow services, the accounting department may pay in currency (for simplicity sake, ABCD dollars) created within a group associated therewith. The payment may be backed up with faith instead of actual cash in dollars. Thus, faith based back-ups may be a feature of intra-organizational processes but may not be a feature of other processes involving inter-organizational/inter-entity transactions.

In one or more embodiments, a group created currency (e.g., for a Palo Alto city group dealing in a currency known as paloalto) may be backed up with a fiat currency such as the U.S. dollar. For example, 10000 paloaltos may be backed up with 100 U.S. dollars. The aforementioned exchange rate may be determined through a democratic voting process implemented in P2P currency network 100.

FIG. 2 shows interaction of a group 202 of data processing devices 102_{1-N} with currency server 150 of P2P currency network 100, according to one or more embodiments. In one or more embodiments, as discussed above, currency server 150 may be coupled to each of data processing devices 102_{1-N} through Internet 104. Again, as discussed above, in one or more embodiments, currency server 150 may be a network of a number of servers, each having one or more functionalities associated therewith. In FIG. 2, group 202 may be a public (open) group or a private (closed) group. One of the users associated with a data processing device 102_{1-N} may be designated as a custodian 204. In one or more embodiments, a custodian 204 may be an individual (or, entity; or, an entity representative) configured to create currency on behalf of group 202. In one or more embodiments, custodian 204 may also enable one or more (or, all) members of group 202 to use the currency via the same computing platform 108_{1-N} on which agent 106_{1-N} is configured to execute.

In one or more embodiments, the abovementioned members of group 202 (via data processing devices 102_{1-N}) may be provided the capability to contribute to the development and/or ongoing management of the currency as will be discussed herein. In one or more embodiments, custodian 204 may form group 202 provided he/she invites at least one other individual user 110_{1-N} to use the currency created. As discussed above, in an example embodiment, custodian 204 may restrict membership to a particular group 202 to people living in the same city, or, employees at the same company. This is an example of a closed (or, private) group 202. In another example embodiment, custodian 204 may leave the membership open to anyone wishing to join group 202. This is an example of an open (or, public) group 202.

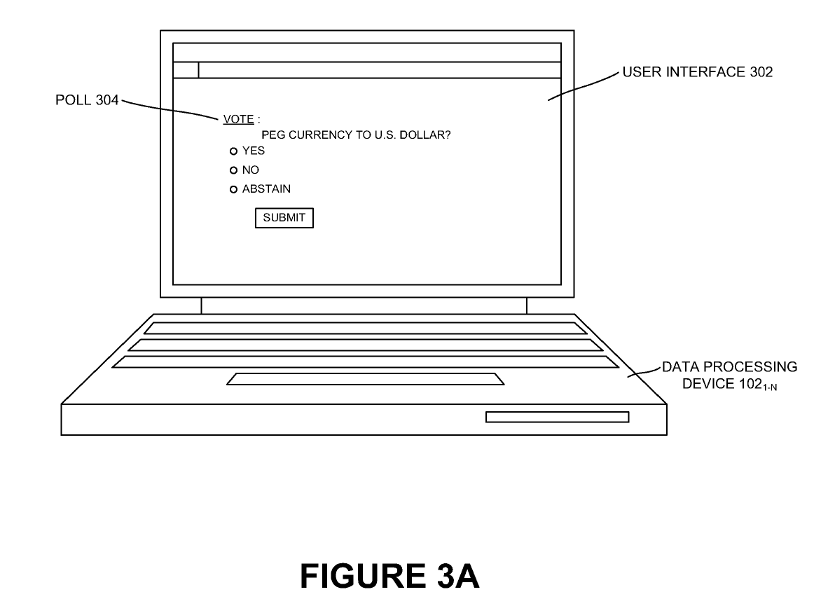

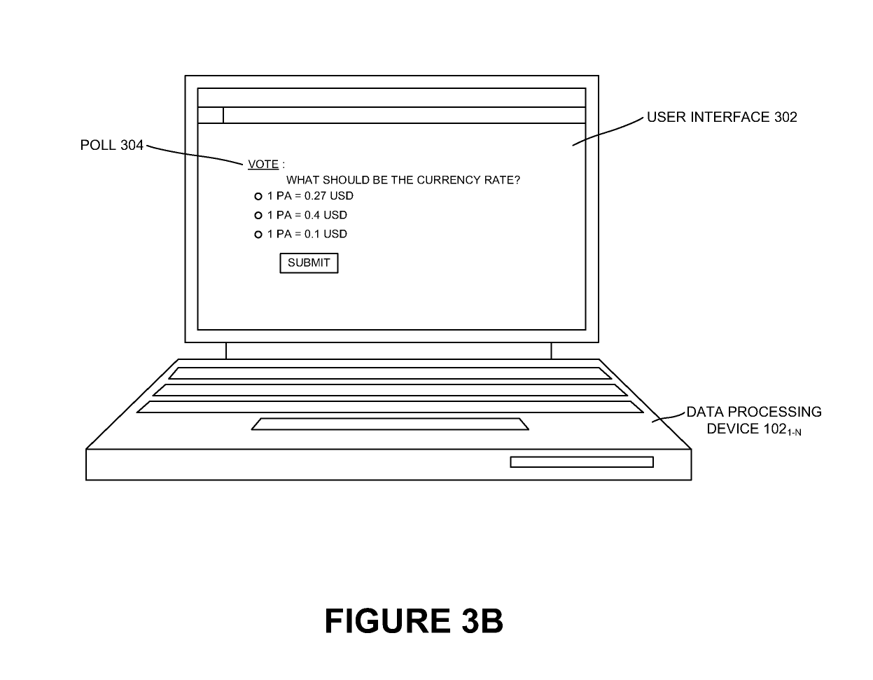

In one or more embodiments, custodian 204 may start an unlimited number of group(s) 202 and computing platform 108_{1-N} may support an unlimited number of groups started by various custodians 204. FIG. 3 shows an example user interface 302 at a data processing device 102_{1-N} of a user 110_{1-N} member of group 202 after custodian 204 initiates a voting process, according to one or more embodiments. In one or more embodiments, a web interface 302 provided through computing platform 108_{1-N} loaded on data processing device 102_{1-N} may show poll 304 with options thereon. For example, poll 304 may be associated with issues such as pegging the currency generated to an official government currency or not (FIG. 3A) and setting the currency exchange rate (FIG. 3B).

FIG. 2 shows currency server 150 as including a processor 190 communicatively coupled to a memory 170. In one or more embodiments, memory 170 may include storage locations configured to be addressable through processor 190. In one or more embodiments, again, there may be a number of processors 190 associated with currency server 150 and a corresponding number of memories 170. FIG. 2 shows one processor 190 and one memory 170 for the sake of convenience. In one or more embodiments, computing platform 108_{1-N} may provide options for protecting the currency against inflation by way of integrating the economic concept of demurrage therein. Just like goods belonging to an entity stored by a third party attract more charges when stored longer, the economic concept of demurrage may be utilized to reduce the value of a currency over time. Thus, user 110_{1-N} is provided an incentive to spend the currency thereof sooner rather than later. The rate at which the value of the currency reduces may be determined intelligently through having real-time world financial data available to currency server 150 (as said above, currency server 150 may be a network of servers including a server configured to provide real-time world financial data).

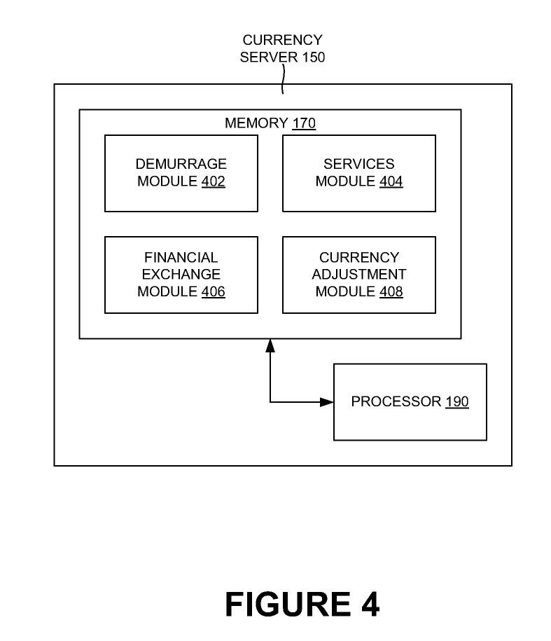

In one or more embodiments, currency server 150 may be platform provider 160 or currency server 150 may execute platform 220 (platform provider 160 may be a third party) corresponding to computing platform 108_{1-N} at member data processing devices 102_{1-N} (and data processing device 102_{1-N} associated with custodian 204). FIG. 4 shows example modules being stored in memory 170 of currency server 150 configured to execute on processor 190, according to one or more embodiments. In one or more embodiments, memory 170 may include a demurrage module 402 including instructions associated with accounting for the decrease in the value of a currency over time. In one or more embodiments, the extent to which demurrage is incorporated (e.g., rate of decrease in value) and/or the time at which demurrage is incorporated may, once again, be determined through the process of democratic voting. For example, member users 110_{1-N} may be provided a list of options to choose from in a poll analogous to the polls shown in FIG. 3.

In one or more embodiments, memory 170 may include a services module 404 configured to enable services such as “physical” printing of currency, minting of currency, “physical” creation of currency and enabling sharing of currency via a variety of media including but not limited to paper, coins, precious metal(s) (e.g., gold) and other object(s). It is obvious that demurrage module 402 may execute on one server and services module 404 on one or more other servers constituting currency server 150 (which may be a network of servers). The same rationale applies to other modules to be discussed herein. In one or more embodiments, users 110_{1-N} may be provided the capability to exchange the currency generated through computing platform 108_{1-N} for government backed currency through utilizing the capabilities of financial exchange module 406 stored in memory 170. In one or more embodiments, financial exchange module 406, when executing on processor 190, may leverage the capabilities of an integrated network of financial instruments and tools (e.g., financial servers part of currency server 150) to enable users 110_{1-N} to realize the aforementioned exchange.

As discussed above, users 110_{1-N} (including custodian 204) may include merchants and customers. In one or more embodiments, users 110_{1-N} may benefit by way of improved efficiency in commercial exchanges; consumers/customers do get “more for less.” Further, in one or more embodiments, as the value of currency is configured to decrease over time, merchants may benefit by the consumers/customers having incentive to spend currency sooner rather than later. In one or more embodiments, consumers/customers may pay a same amount for more returns, with merchants benefiting by way of the probability of a sale being increased (compared to fiat currency) through P2P currency network 100.

In one or more embodiments, P2P currency network 100 may benefit a cash-strapped community by providing the initiative to start a minor economic system therewithin. In one or more embodiments, challenges to capital access may be resolved and the local community may be able to pull itself by the “bootstraps.” In one or more embodiments, if no one else invests in the cash-strapped community, members thereof may invest in each other. Additionally, in one or more embodiments, one cash-strapped community may invest in another cash-strapped community, thereby providing for mutual symbiosis.

In one or more embodiments, when assets (currency) are to be liquidated, every holder of the currency may be notified. Again, in one or more embodiments, the voting system may be employed to seek permission from the holder(s) (users 110_{1-N}). In one or more embodiments, when the backup official currency is increased in value, each user 110_{1-N} may get more of the generated currency. In one or more embodiments, when the backup official currency is decreased in value, some of the generated currency is retired. Thus, in one or more embodiments, holder(s) (users 110_{1-N}) of currency do not lose value thereof and are protected against factors such as inflation. The aforementioned processes may, again, execute on processor 190 of currency server 150 by way of an appropriate module (e.g., currency adjustment module 408) being stored in memory 170.

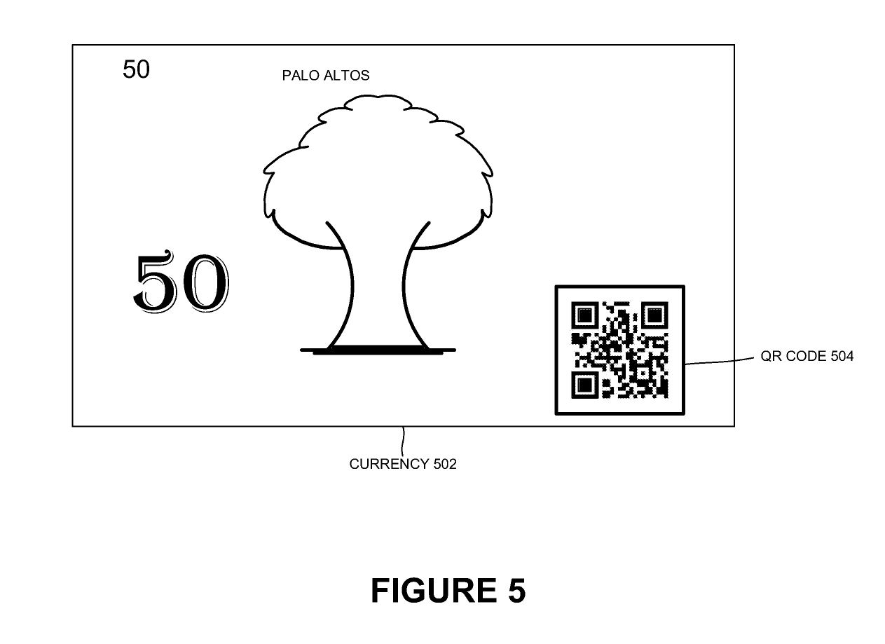

In one or more embodiments, as discussed above, physical printing of currency may also be possible. As government regulations (e.g., regulations in the United States) may deem it illegal for privately generated currency to resemble official currency, the physically printed currency may have designs different from that of official currency. FIG. 5 shows an example paloalto currency 502 generated. Currency 502 shows 50 paloalto units as an example illustration. The city group 202 may have opted for an environment-theme and, therefore, currency 502 shows a symbolic tree constituting a design thereof. Additionally, currency 502 may have a watermark (not shown) embedded therein. In FIG. 5, currency 502 may also have a QR code 504 embedded therein. Thus, user 110_{1-N} may be provided the capability to present the aforementioned currency 502 to a merchant (accepting currency 502 of course) in exchange for good(s) and/or service(s), following which the merchant scans QR code 504 for authentication purposes using an appropriate reader device (e.g., a mobile phone having the capability to read QR codes).

Other forms of fingerprinting including but not limited to utilizing Near-Field Communication (NFC) tags and barcodes are within the scope of the exemplary embodiments. In one or more embodiments, custodian 204 who starts a community through group 202 and controls currency 502 may be analogous to the Federal Reserve chairman. In one or more embodiments, as discussed above, custodian 204 may have the power to initiate a demurrage (or, decreasing the value of currency 502 over time) to incentivize current spending of currency 502. In one or more embodiments, custodian 204 may only possess the aforementioned powers of demurrage initiation, exchange rate setting and/or others based on a democratic policy vote process in which members of group 202 participate.

In one or more embodiments, the backup currency may be installed in a linked account (e.g., a Paypal® account; Paypal® server may be considered to be a part of the network of servers forming currency server 150) overseen by an administrator (e.g., administrator 214 on data processing device 102_{1-N}; administrator 214 may be a member of group 202, may be custodian 204 or may not be a member of group 202) of P2P currency network 100. In one or more embodiments, the aforementioned account may be linked to both the administrator account on P2P currency network 100 and the custodian account. In one or more embodiments, equivalence may be maintained to currency 502 (e.g., paloalto) being circulated through custodian 204. In one or more embodiments, whenever custodian 204 initiates a demurrage, computing platform 108_{1-N} may be configured to send a poll to members of group 202. In one or more embodiments, custodian 204 may possess the power to start the voting on a certain day and end the voting on another. In one example embodiment, members of group 202 may vote Yes/No or abstain from the voting process.

In one or more embodiments, transactions may be sortable on a member basis. In one or more embodiments, every currency transaction occurring through P2P currency network 100 may be recorded and stored (e.g., in non-volatile storage) in memory 170. In countries such as United States requiring all profits and losses based on transactions to be reported, the aforementioned storage in memory 170 may be mandatory to ease reporting of transactional data to the government (e.g., to a governmental server). For example, currency server 150 may directly link the transactional data stored in memory 170 to a TurboTax® server (which can be considered to be part of or associated with currency server 150).

In one or more embodiments, P2P currency network 100 may be imagined to be a stock market where members of group 202 buy/sell real assets and/or trade currencies (e.g., currency 502). In one or more embodiments, members may buy futures and/or goods on currency 502. The Figures described above would suffice to understand the stock market implementation. In one example embodiment, P2P currency network 100 may also work as a loan system where an entity (e.g., individual) may place a house thereof in an escrow account and put in a down payment and a collateral. The entity may obtain a loan therefor in currency 502. The aforementioned currency 502 loan may be utilized for payments. Here, custodian 204 may act as a banker.

In the example embodiment involving an entity (e.g., an individual) as a borrower (e.g., borrower of currency 502 for house payments) with regard to P2P currency network 100, a subsequent activity of the entity (e.g., promptness of payment of loan installments, or lack thereof), may be monitored through P2P currency network 100. Currency server 150 may leverage data (e.g., credit card data, credit rating) from third party servers (e.g., credit data servers) that are either part of currency server 150 or external thereto to obtain a profile of the borrower. Based on the activity of the profiled borrower, the borrower may have the obligation thereof (e.g., interest rate, loan amount sanctioned) modified (e.g., increased, reduced). Here, the borrower and the loan provider may transact through corresponding data processing devices 102_{1-N} associated therewith.

The abovementioned profiling may also occur prior to the loan being sanctioned, thereby providing for the ability to tailor interest rates based on the “risk” profile of the borrower. The profiling may also occur during the loan period, and the borrower may have the obligation thereof revised based on behavior. Other acts of revision may include crediting an amount to currency 502 associated with the entity (e.g., borrower) or decreasing an amount therefrom. Other activities of the borrower such as carbon friendliness (or, optimum fuel consumption) may also contribute to the profiling thereof and, thereby, to the credits available to the borrower. The aforementioned activities are within the scope of the exemplary embodiments.

In one or more embodiments, an entity may be prevented from creating the same currency as another by filing an appropriate trademark and/or employing close comparison matches of the currency (through modules stored in memory 170 executing on processor 190 of currency server 150). In one or more embodiments, upholding legal standards and standards of third-parties such as Paypal® may help prevention of scenarios such as an entity bringing in illegal drugs into the picture (e.g., by way of pawning the aforementioned illegal drugs in exchange for good(s), currency and/or service(s)). For example, entities may be restricted to using Paypal® to put in the escrow account thereof, with collateral being restricted to things depositable in a bank.

Thus, in one or more embodiments, P2P currency network 100 may be imagined to be a pawn-brokering system. In one or more embodiments, P2P currency network 100 may enable creation of currency 502, utilization of said currency 502 in a community (or, group 202) and paying for service(s) and/or good(s) by way of currency 502 (or, government regulated currency).

In one or more embodiments, revenue for a service provider (e.g., platform provider 160, provider of agent 106_{1-N}) may be based on transaction of commissions. In one or more embodiments, service charges for a transaction may be much less in comparison to other entities such as banks.

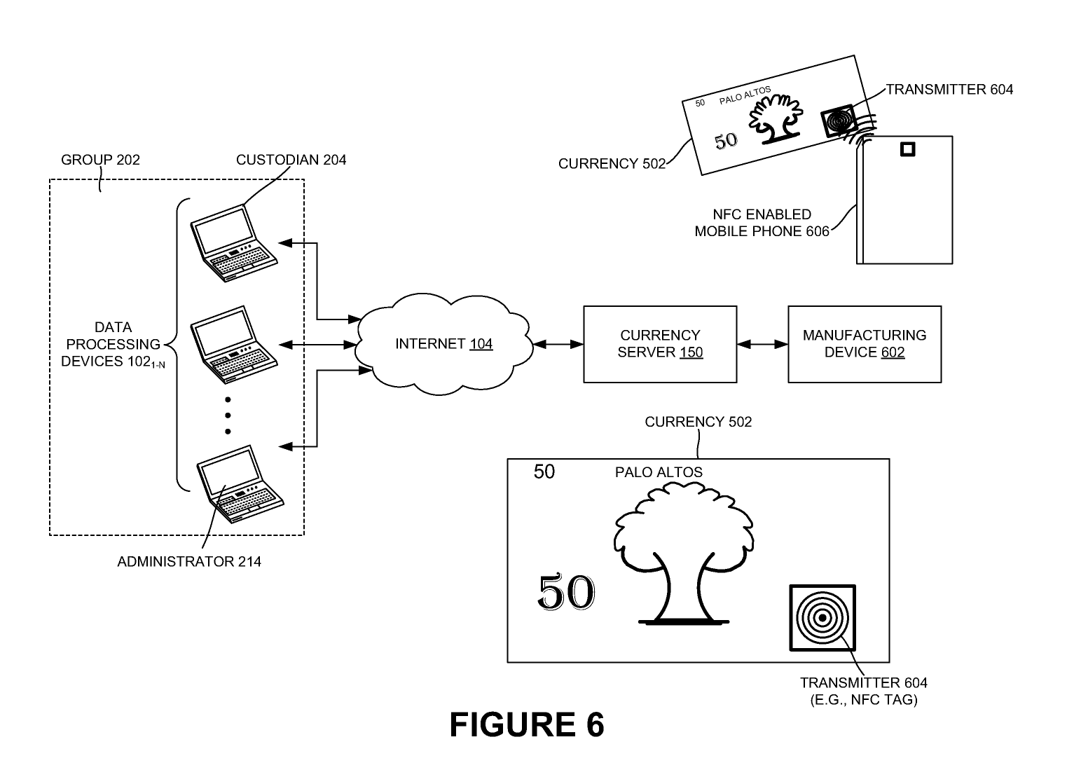

FIG. 6 shows a user case scenario of P2P currency network 100 being utilized with geospatial constraints. In one embodiment, custodian 204 may create currency 502 for a closed group 202 whose members are within the same zip code, the same city, within a college campus or an office complex (or, parameters determined by custodian 204). Custodian 204 may create and administer currency 502 online through P2P currency network 100. Currency server 150 may be associated with or include a manufacturing device 602 that automatically generates currency 502 based on market conditions (e.g., implemented in a module stored in memory 170) and/or custom rules defined by custodian 204.

The physical version of currency 502 may be in paper, plastic, metal or in another lightweight form, and may include transmitter 604 (e.g., NFC tag) embedded therein configured to transmit data such as location and usage pattern (and/or others, of course) to currency server 150. For example, when an NFC enabled mobile phone 606 reads currency 502 for authentication during a transaction, transmitter 604 may be configured to read geospatial coordinates of the transaction through NFC enabled mobile phone 606 (e.g., through GPS feature of mobile phone 606). The physical version of currency 502 may also be within electronic device(s) capable of downloading and uploading information related to location, currency value, exchange rate(s) and other market data.

Custodian 204 may create currency 502 to be used solely within the defined geospatial limits. In order to ensure that the physical version of currency 502 is solely used within the geospatial limits, transmitter 604 may periodically update currency server 150 with information thereof. In an example implementation, the physical version of currency 502 may also include a light emitting feature associated therewith during reading of transmitter 604 that puts the other party to ease regarding the authorization thereof within the geospatial limits. For example, a green light when read may indicate that currency 502 is acceptable within the geospatial limits. A red light may indicate to the other party that currency 502 is not acceptable within the geospatial limits. Currency server 150 may also be configured to track transactions based on transmitter 604. The data transmitted to currency server 150 may, for example, be utilized in tracking detailed spending patterns within a city, thereby serving as valuable data for entities such as businesses and governments.

Currency naming conflicts may be resolved through currency server 150 executing appropriate comparison modules (not shown) stored in memory 170. The algorithm associated with a comparison module may take into account factors such as accepting/rejecting names based on geospatial limits, dictionary definitions, user data, popular culture references, slang and government databases (e.g., trademark databases) with information on city names and landmarks. Also, names deemed unfit such as names based on existing government currency, curse words and distasteful words (and names) may be rejected.

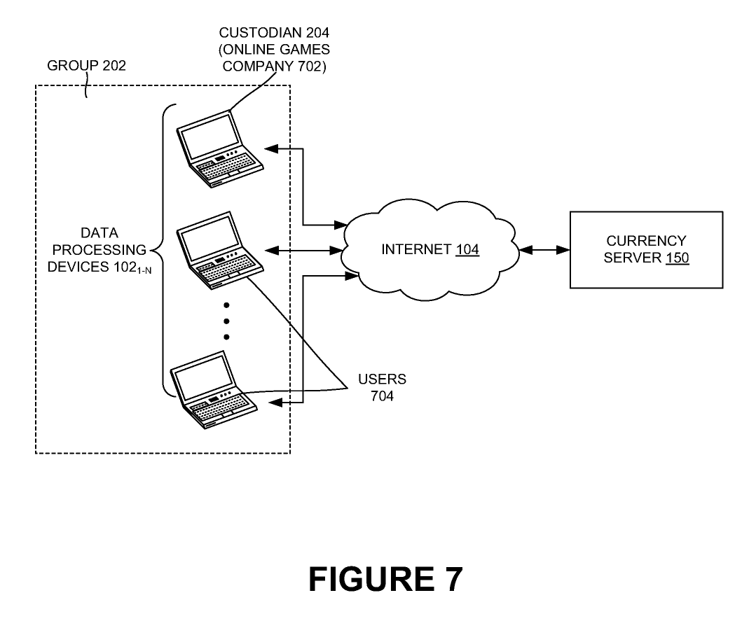

FIG. 7 shows another use case scenario of P2P currency network 100 being utilized as a gaming system. P2P currency network 100 may be utilized by online gamers for a variety of social, role playing and/or gambling games. Here, a single currency (e.g., currency 502) may be utilized across a number of games and categories thereof, or currency 502 may be limited in use within a single game or game category.

Again, custodian 204 may create currency 502 to be used for online games. A member of group 202 may want to use currency 502 within the gaming setup to acquire certain game advantages, exchange virtual goods and/or services, and/or place bets. Again, group 202 may be a private (or, closed group). Custodian 204, for example, may limit currency exchanges within group friends and utilize the aforementioned currency exchanges to measure the win-loss record(s) of one or more friend(s). Custodian 204 may also want to allow anyone to use currency 502 across multiple games as a way of combining fun associated with multiple games into one game and/or as a way of providing game winners with more currency 502 to be utilized for winning games.

In FIG. 7, custodian 204 may be an online games company 702, which creates separate currencies for each of the games thereof, one currency 502 for all the games or a combination thereof. User(s) 704 may purchase currency 502 with government regulated currency such as U.S. dollars or other credit/debit card methods/online payment methods. Here, currency 502 may be configured to lose value over a time period specified by online games company 702 to incentivize users 704 to use currency 502 quickly. The aforementioned implementation may prompt users 704 to spend more time playing games for the “thrill of it.” Online games company 702 may benefit by the higher level of user engagement and the increased prospects of purchases. Online games company 702 may later be able to exchange collected currency with U.S. dollars (or any other currency).

In another implementation, users 704 may also be able to purchase virtual goods such as virtual clothing, virtual armor and virtual body adaptations that are part of game(s) associated therewith. The abovementioned loss of value over time may motivate users 704 to quickly acquire the virtual goods to enhance the gaming experience thereof. Online games company 702 may benefit by the increased user level of interaction and, of course, virtual purchases.

It is obvious that other features such as user bets may be enhanced in number through the loss of value of currency 502 over time. Also, other implementations such as paying in currency 502 for a sustained gaming experience on part of a user 704 following a prospective stalling thereof may be envisioned. In yet another example, a user 704 may have plenty of currency 502 earned with time and effort. Another user 704 may require more currency 502 to enhance gaming experience thereof. The another user 704 may trade government backed currency for at least some currency 502 of user 704 to realize objective(s) thereof. For the aforementioned purpose, currency server 150 may alert user(s) 704 of the aforementioned trading opportunity during individual gaming experience(s).

It is obvious that uniformity in agent 106_{1-N}/computing platform 108_{1-N} is key to the currency generation and management through data processing devices 102_{1-N}. Further, agent 106_{1-N} configured to execute on computing platform 108_{1-N} may be available as a set of instructions embodied in a machine-readable storage medium (e.g., Compact Disc (CD), Digital Video Disc (DVD), hard disk) or as a download from a server (e.g., currency server 150). The aforementioned download may be installed on data processing device 102_{1-N} on a hard disk thereof. In one or more embodiments, download(s) compatible with data processing device(s) 102_{1-N} such as mobile phones may also be available. The execution of agent 106_{1-N} on data processing device 102_{1-N} may enable access to demurrage (e.g., currency value based on the demurrage) implemented through currency server 150.

Further, it is obvious that reward systems associated with currency transactions may be enabled on another third-party computing platform. Also, it is obvious that currencies may be purchased through online banking/debit cards/credit cards (banking servers and credit card servers being associated with or being part of currency server 150).

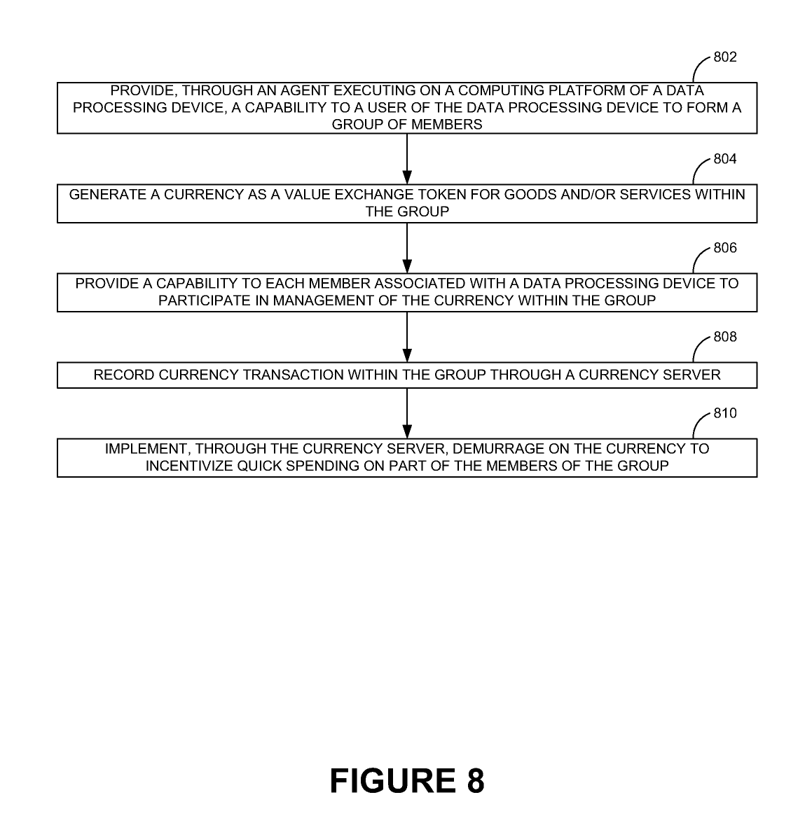

FIG. 8 shows a process flow diagram detailing the operations involved in a method of realizing a P2P currency platform (e.g., P2P currency network 100) incorporating demurrage, according to one or more embodiments. In one or more embodiments, operation 802 may involve providing, through agent 106_{1-N} executing on computing platform 108_{1-N} at data processing device 102_{1-N}, a capability to user 110_{1-N} of data processing device 102_{1-N} to form a group 202 of members, each of the members being associated with data processing device 1021-N coupled to data processing device 102_{1-N} forming group 202 through Internet 104.

In one or more embodiments, operation 804 may involve generating, through data processing device 102_{1-N} forming group 202, currency 502 to be distributed across the members as a value exchange token for goods and/or services within group 202. In one or more embodiments, operation 806 may involve providing a capability to each member associated with data processing device 102_{1-N} to participate in management of currency 502 within group 202. In one or more embodiments, operation 808 may involve recording currency transactions within group 202 through currency server 150 coupled to each of data processing devices 102_{1-N} through Internet 104.

In one or more embodiments, operation 810 may then involve implementing, through currency server 150, demurrage on currency 502 to incentivize quick spending on part of the members of group 202. In one or more embodiments, the demurrage may be associated with a decrease in value of currency 502 over time. In one or more embodiments, currency server 150 may be a server or a network of servers.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method comprising:
providing, through an agent executing on a computing platform at a data processing device, a capability to a user of the data processing device to form a group of members, each of the members being associated with a data processing device coupled to the data processing device forming the group through Internet;
generating, through the data processing device forming the group, a currency to be distributed across the members as a value exchange token for at least one of goods and services within the group;
providing a capability to each member associated with a data processing device to participate in management of the currency within the group;
recording currency transactions within the group through a currency server coupled to each of the data processing devices through the Internet; and
implementing, through the currency server, demurrage on the currency to incentivize quick spending on part of the members of the group, the demurrage being associated with a decrease in value of the currency over time, and the currency server being one of: a server and a network of servers.

2. The method of claim 1, wherein the management of the currency within the group includes at least one of creation, distribution, administration and exchange of the currency.

3. The method of claim 1, wherein a member of the group is one of: an individual, a community, an organization, a department of the organization, a city, a state and a country.

4. The method of claim 1, wherein the group is one of:
a public group open to everyone with a data processing device executing the agent on the computing platform, and
a private group with restricted membership based on a parameter set by the user forming the group.

5. The method of claim 1, further comprising backing the distributed currency with government regulated currency through at least one of the data processing device forming the group and the currency server.

6. The method of claim 1, further comprising:
initiating, through the data processing device forming the group, a poll regarding a policy associated with the currency for the members to vote in; and
implementing, through the currency server, the policy solely based on a result of the voting associated with the poll.

7. The method of claim 6, wherein the policy is based on at least one of: the demurrage implemented, pegging the currency to a government regulated currency and an exchange rate associated with the currency.

8. The method of claim 1, further comprising providing at least one of printing and minting services associated with the currency through the currency server.

9. The method of claim 5, further comprising retiring at least some of the generated currency when the backup government regulated currency is decreased in value.

10. The method of claim 8, further comprising providing, through the currency server, a capability to the printed currency to be fingerprinted.

11. The method of claim 10, wherein the fingerprint of the currency is one of: a watermark, a QR code, a Near-Field Communications (NFC) tag and a barcode configured to be read by an appropriate reader device.

12. The method of claim 5, further comprising installing the backup government regulated currency in a linked account associated with the currency server.

13. The method of claim 1, further comprising providing, through the currency server, a capability to report profits and losses associated with the transactions within the group to a server associated with a governmental authority.

14. The method of claim 1, further comprising generating, through the currency server, revenue for a provider of at least one of the agent and the computing platform based on a commission associated with each transaction within the group.

15. The method of claim 1, further comprising providing a capability to at least one of:
borrow, through a data processing device, currency from a member of the group;
monitor, through the currency server based on data available from a third party server, activity of the borrowing member;
profile, through the currency server, the borrowing member based on the monitored activity thereof; and
modify at least one of a currency obligation and a currency credit of the borrowing member based on the profiling.

16. A peer-to-peer (P2P) currency network comprising:
a plurality of data processing devices, each data processing device being configured to execute an agent on a computing platform thereat;
a network; and
a currency server coupled to the plurality of data processing devices through the network, the currency server being one of: a server and a network of servers,
wherein the agent on a data processing device is configured to enable a user thereof to form a group of members, each of the members being associated with a data processing device of the plurality of data processing devices,
wherein the agent is further configured to provide the user of the data processing device forming the group a capability to generate a currency to be distributed across the members as a value exchange token for at least one of goods and services within the group,
wherein the agent at each data processing device is configured to provide a corresponding member with a capability to participate in management of the currency within the group,
wherein the currency server is configured to record currency transactions within the group, and
wherein the currency server is further configured to implement demurrage on the currency to incentivize quick spending on part of the members of the group, the demurrage being associated with a decrease in value of the currency over time.

17. The P2P currency network of claim 16, wherein the group is one of:
a public group open to everyone with a data processing device executing the agent on the computing platform, and
a private group with restricted membership based on a parameter set by the user forming the group.

18. The P2P currency network of claim 16, wherein the currency server is configured to install backup government regulated currency in a linked account associated therewith.

19. The P2P currency network of claim 16, wherein the currency server is configured to generate revenue for a provider of at least one of the agent and the computing platform based on a commission associated with each transaction within the group.

20. The P2P currency network of claim 16,
wherein the data processing device forming the group is provided a capability to initiate a poll regarding a policy associated with the currency for the members to vote in, and
wherein the currency server is configured to implement the policy solely based on a result of the voting associated with the poll.

21. A storage medium, readable through a data processing device and including instructions embodied therein configured to executable through the data processing device, comprising:
instructions associated with providing a capability to a user of the data processing device to form a group of members, each of the members being associated with a data processing device coupled to the data processing device forming the group through Internet;
instructions associated with generating a currency to be distributed across the members as a value exchange token for at least one of goods and services within the group;
instructions associated with providing a capability to each member associated with a data processing device to participate in management of the currency within the group; and
instructions associated with accessing, from a currency server configured to record currency transactions within the group coupled to each of the data processing devices through the Internet and implement demurrage on the currency, a value of the currency in accordance with the demurrage implemented to enable incentivizing a member to quickly spend currency associated therewith, the demurrage being associated with a decrease in value of the currency over time, and the currency server being one of: a server and a network of servers.
